(19) United States
(12) Patent Application Publication
(10) Pub. No.: US 2009/0031239 A1
(43) Pub. Date: Jan. 29, 2009

(54) ASSET BROWSER FOR COMPUTING ENVIRONMENT

(75) Inventors: Mark Coleran, Ottawa (CA); Adam Frankowski, Ottawa (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: GRIDIRON SOFTWARE INC., Ottawa (CA)

(21) Appl. No.: 12/175,232

(22) Filed: Jul. 17, 2008

Related U.S. Application Data
(60) Provisional application No. 60/950,166, filed on Jul. 17, 2007.

(51) Int. Cl. G06F 3/048; G06F 17/30

(52) U.S. Cl. 715/771; 707/103 R; 707/E17.055; 707/E17.01

(57) ABSTRACT

A method and system are provided for browsing assets stored in memory in a computing environment. Asset interdependence is used as a central model for organizing and displaying assets in an asset map. The asset map is a visual representation an asset of interest and a set of assets having a logical usage relationship with the asset of interest. The asset map preferably concurrently shows the related assets, their relationships, and a location of the assets on storage media in the computing environment. The assets are shown as nodes on a map with visual indicators describing relationships between them. Component assets are shown as assets used in an asset of interest, and output assets are shown as outputs generated using the asset of interest. These assets, or data entities, include applications, files, folders, fonts, effects, image layers, animation compositions, video tracks, and audio tracks.

### CROSS REFERENCE TO RELATED APPLICATIONS

This application claims the benefit of priority of U.S. Provisional Patent Application No. 60/950,166 filed Jul. 17, 2007, which is incorporated herein by reference in its entirety.

This application is related to the following applications: U.S. Provisional Patent Application No. 60/950,155 filed on Jul. 17, 2007 and entitled “Automatic File Versioning”; U.S. Provisional Patent Application No. 60/950,158 filed on Jul. 17, 2007 and entitled “Indexing Through File Format Understanding”; U.S. Provisional Patent Application No. 60/950,159 filed on Jul. 17, 2007 and entitled “Method and Apparatus for Workflow Versioning”; U.S. application Ser. No. ______ (Attorney Docket No.: PAT 4299-2) entitled “Automatic Workflow Versioning” and filed of even date herewith; and U.S. application Ser. No. ______ (Attorney Docket No.: PAT 4294-2) entitled “Automatic File Versioning” and filed of even date herewith.

### FIELD OF THE INVENTION

The present invention relates generally to computing environments. More particularly, the present invention relates to the display of relationships between data files.

### BACKGROUND OF THE INVENTION

Computing environments enable users to create and modify documents and other files using a number of application programs, often simply referred to as programs or applications. Desktop and other computing environments include an operating system, which enables a user to store and organize files in different folders. Most operating systems provide a number of different manners in which to view files and folders, such as in a tree view. These views only show relationships between files and folders in terms of how the files or documents are stored hierarchically on the computer, or other storage media.

In many instances, a user creates a number of different documents that are stored in different locations, or created by different applications, yet are related to one another. Moreover, it has now become common for a number of different users to collaborate on a particular project and create a number of different files in the process of undertaking that project. Workflow can change over time as users add data files to a project and make changes to existing files. Desktop computing environments are not equipped to determine and display relationships between documents or data files, creating a deficiency in these systems.

Some browsing applications, to browse files and folders, exist within an operating system, and others are provided as separate add-on applications. Existing browsing applications display data in one of the following two ways:

1. Hierarchical (tree) view.
2. Saved searches (using metadata), or other dependency indication.

Tree view browsing organizes data into purely parent/child-based relationships. Some systems show files as nodes in the tree, others treat only folders as tree nodes, and some provide a pyramid view showing both folders and sub-folders.

Metadata search tools use data commonality to group files containing like metadata. These searches can be saved, appearing as folders with dynamic content. The files may reside in differing locations on the storage medium but appear as children of a common parent that is the saved search “folder”.

Other approaches exist to show file properties, including when a file is dependent on another file. For example, if an image is included in a word processing document, metadata associated with the document can indicate that the image file saved on a computer is related to the word processing document also saved on the computer. However, this information is not provided in a file browser application or at a file browser level, but is typically buried in a file properties dialog box or a similar location.

In the domain of software development, some tools provide browsing and display of relationship information for pieces of code that are being used in a piece of software being developed. However, these tools are for use by computer programmers in a development environment of uncompiled software code, and cannot be used by a regular computer user manipulating documents or other files on a computer operating system. Moreover, these tools display relationship information in the context of the software development tool, and do not indicate relationships that are relevant outside of the development tool.

In the techniques mentioned, files are either displayed in relation to their storage location (as in tree view), or in relation to data commonality. However, in many cases, it would be advantageous to display both of these types of information at the same time. Moreover, regardless of the manner in which individual files are displayed (large thumbnail, small thumbnail, icon, name only, etc) in known techniques, they are based on a parent/child relationship model. There are clearly limitations to such a model, such as in a media production environment where files and other data entities can be related to each other in complex manners that are not adequately represented by parent/child models such as a binary tree.

It is, therefore, desirable to provide an approach that overcomes drawbacks of existing file browsing mechanisms.

### SUMMARY OF THE INVENTION

It is an object of the present invention to obviate or mitigate at least one disadvantage of previous file browsing approaches.

In an aspect, the present invention provides a graphical user interface providing an ordered display of assets stored in memory in a computing environment, the assets being logically related to one another with respect to use. The graphical user interface includes an asset map displaying an asset of interest and a plurality of assets having a logical usage relationship with the asset of interest. The asset map includes a root area, a component area, and an output area. The root area concurrently displays an asset of interest and a location on storage media of the asset of interest. The component area concurrently displays one or more component assets, a location on storage media of the one or more component assets, and a visual indication that the component assets are used in the asset of interest. The output area concurrently displays one or more output assets, a location on storage media of the one or more output assets, and a visual indication that the output assets are outputs generated using the asset of interest.

In an embodiment, the visual indication that the component assets are used in the asset of interest includes a component branch extending from the root area to the one or more component assets. The visual indication that the output assets are outputs generated using the asset of interest can include an output branch extending from the root area to one or more output assets.

The component assets can include a direct component asset that is that is directly used in the asset of interest. The component assets can include an indirect component asset that is a component of the direct component asset and is indirectly used in the asset of interest.

The displayed location on storage media of the asset of interest, the displayed location on storage media of the one or more component assets, or the displayed location on storage media of the one or more output assets can include a complete physical storage path, or a partial indication of the physical storage location. In the case of the partial indication, additional physical storage location information can be displayed in response to a related request.

In another embodiment, the visual indication that the component assets are used in the asset of interest includes locating the component area in a first visual relationship with respect to asset of interest. The visual indication that the output assets are outputs generated using the asset of interest can include locating the output area in a second visual relationship with respect to the asset of interest.

The graphical user interface can further include a tracker to visually highlight the asset of interest and show the related component and output assets in a currently viewed area as it relates to a total viewable area. A dashboard can be provided to show asset names and associated properties of recently modified assets that are logically related to the asset of interest.

The asset map can further concurrently display one or more of the following: a total edit time for at least one displayed asset; a version number for at least one displayed asset; a version history for at least one displayed asset; a user name associated with at least one displayed asset.

In response to user selection of a selected asset, the asset map can further concurrently display command options available for the selected asset, the command options being provided in a floating menu around the selected asset. For a selected asset in the asset map, the asset map can associate a unique visual indicator with a set of assets that are affected if the selected asset were to be modified.

In another aspect, the present invention provides a system for browsing assets stored in memory in a computing environment, the assets being logically related to one another with respect to use. The system includes an asset information acquirer and an asset map generator. The asset information acquirer obtains logical usage relationship information and storage information for an asset of interest and for a plurality of assets that have a logical usage relationship with the asset of interest. The asset map generator generates an asset map concurrently displaying the asset of interest and the plurality of related assets, a location on storage media of the asset of interest and the plurality of related assets, and a visual indication of a nature of the logical usage relationship between the asset of interest and each of the plurality of related assets.

In an embodiment, the displayed plurality of related assets comprise component assets used in the asset of interest, and output assets generated using the asset of interest. The system can further include: a logical usage relationship extractor to obtain logical usage relationship information for the asset of interest and for the plurality of related assets; and a storage information extractor to obtain storage information for the asset of interest and for the plurality of related assets. The asset information acquirer and the asset map generator can be provided independent of an application in which assets are generated.

In a further aspect, the present invention provides a method for browsing assets stored in memory in a computing environment, the assets being logically related to one another with respect to use, including the following steps: obtaining logical usage relationship information and storage information for an asset of interest and for a plurality of assets that have a logical usage relationship with the asset of interest; and concurrently displaying: the asset of interest and the plurality of related assets, a location on storage media of the asset of interest and the plurality of related assets, and a visual indication of a nature of the logical usage relationship between the asset of interest and each of the plurality of related assets.

In a yet further aspect, the present invention provides a computer readable medium containing computer instructions which, when executed, cause a processor to provide a graphical user interface for browsing assets stored in memory in a computing environment, including: instructions for obtaining logical usage relationship information and storage information for an asset of interest and for a plurality of assets that have a logical usage relationship with the asset of interest; and instructions for concurrently displaying: the asset of interest and the plurality of related assets, a location on storage media of the asset of interest and the plurality of related assets, and a visual indication of a nature of the logical usage relationship between the asset of interest and each of the plurality of related assets.

In another aspect, the present invention provides an ordered tree structure representing assets stored in memory in a computing environment, including a root node representing an asset of interest, one or more component assets and one or more output assets. A component branch extends from the root node to the one or more component assets. The component branch indicates that the component assets are used in the asset of interest. An output branch extends from the root node to one or more output assets. The output branch indicates that the output assets are outputs generated using the asset of interest.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates a display based on an asset browsing system according to an embodiment of the present invention;

FIG. 2 illustrates a display based on an asset browsing system according to another embodiment of the present invention;

FIG. 3 illustrates a display based on an asset browsing system according to a further embodiment of the present invention;

FIGS. 4-15 Illustrate screenshots of displays for an exemplary asset browsing system according to an embodiment of the present invention;

FIG. 16 illustrates a network diagram including a plurality of entities according to embodiments of the present invention; and

FIG. 17 illustrates a block diagram of a client design according to an embodiment of the present invention.

### DETAILED DESCRIPTION

Generally, the present invention provides a method and system for browsing assets stored in memory in a computing environment. Asset interdependence is used as a central model for organizing and displaying assets in an asset map. The asset map is a visual representation an asset of interest and a set of assets having a logical usage relationship with the asset of interest. The asset map preferably concurrently shows the related assets, their relationships, and a location of the assets on storage media in the computing environment. The assets are shown as nodes on a map with visual indicators describing relationships between them. Component assets are shown as assets used in an asset of interest, and output assets are shown as outputs generated using the asset of interest. These assets, or data entities, include applications, files, folders, fonts, effects, image layers, animation compositions, video tracks, and audio tracks.

Tree view and metadata search tools browsing have been described as deficient since they are based on a model of a parent/child relationship approach to file browsing. This deficiency is particularly evident in video production, web publishing and desktop publishing. In video production it is not unusual for a user to use 10 different application tools, creating hundreds of files.

For instance:

still raster graphics may be done by importing photographs into Adobe Photoshop,

still vector graphics may be created in Adobe Illustrator

motion graphics may be done in Adobe After Effects after having imported Photoshop and Illustrator files. The After Effects project may be used to generate two movie files, one with time codes embedded and one without.

The movie with time codes may be imported into ProTools to do sound design. The ProTools project may generate audio files.

The audio files and movie without time codes may be imported into Final Cut Pro for video editing. The output from Final Cut Pro might be a movie with both audio and video.

The movie output from Final Cut might be imported into Compressor to do encoding to a compressed format for distribution on the web and DVD.

Most video production workflows are much more complex than the description provided above. Additionally, the process followed to achieve the end results often involves much iteration or editing of existing files.

Embodiments of the present invention can be described as a method for asset browsing, a system for asset browsing, a graphical user interface for asset browsing, and/or a computer-readable medium storing statements and instructions which, when executed, cause a processor to perform the method or provide the graphical user interface. Description will now be provided with respect to a visual display, which can be a product of the method, the system, or the computer-readable medium, and can be referred to as the user interface.

To display asset browsing information according to an embodiment of the present invention, there is preferably the ability to provide, or have access to, one or more of the following features: automatic versioning of data files or assets; automatic creation of a database of metadata describing the relationships between data files or assets, preferably including version/timestamp information such that relationships can be tracked against time and file, or asset, versions; visualizing a workflow and how it changes over time.

A method to automatically version data files is described in U.S. Provisional Patent Application No. 60/950,155 filed on Jul. 17, 2007 and entitled “Automatic File Versioning”, which is incorporated herein by reference.

A means for automatically determining workflow relationships between data files is described in co-pending U.S. Provisional Patent Application No. 60/950,158 filed on Jul. 17, 2007 and entitled “Indexing Through File Format Understanding”, which is incorporated herein by reference.

A method of tracking how file versions and relationship versions change over time, such as described above, is described in co-pending U.S. Provisional Patent Application No. 60/950,159 filed on Jul. 17, 2007 and entitled “Method and Apparatus for Workflow Versioning”, which is incorporated herein by reference.

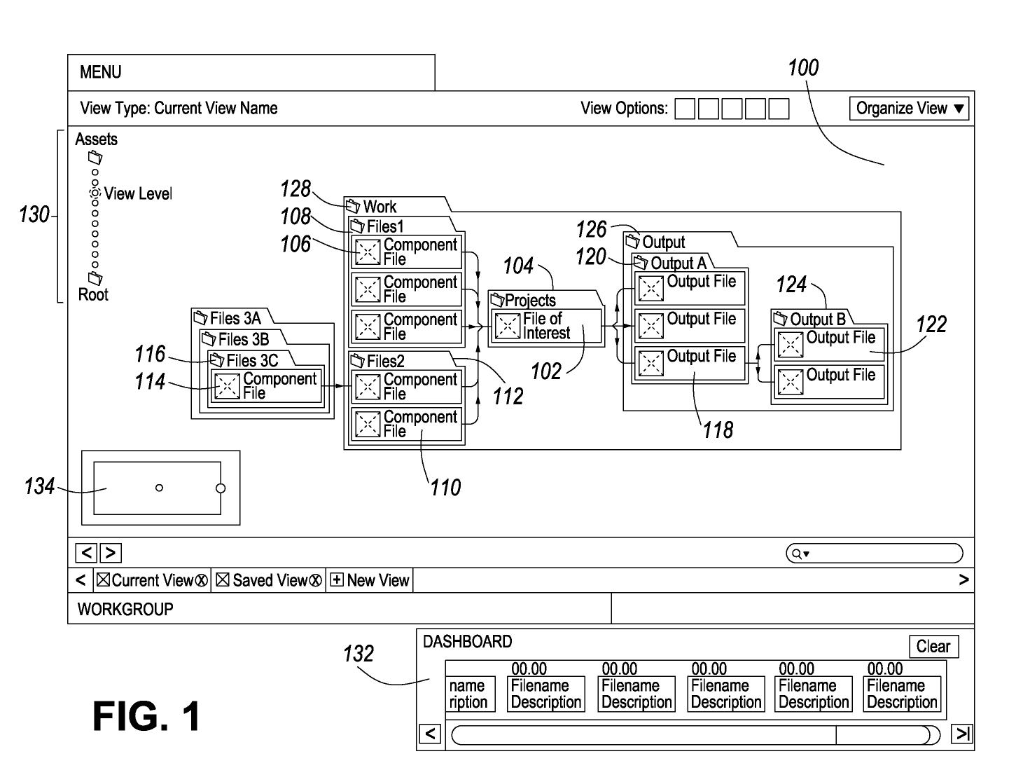

FIG. 1 illustrates a display based on an asset browsing system according to an embodiment of the present invention. The display can be described as a pyramid view, or pyramid browsing. The display can be referred to as a graph, or a named collection of Nodes and Links, which can be used to visualize a workflow and provide associated versioning information. Nodes, Links and Graphs can also have key/value pair based metadata associated with them. The display can also be referred to as a graphical user interface.

The display in FIG. 1 can be based on a method of visualization according to an embodiment of the present invention, which provides the benefit of imparting two concurrent yet complementary notions of data context. Not only does the display indicate how assets are related to one another, it can also simultaneously indicate how those assets are related to computer storage. The result is a layering of asset and folder information in a contextual composite view.

In the main portion of FIG. 1, an asset map area 100 is provided. It is in the context of the asset map that the concept of pyramid browsing comes to bear. The asset map is created from the perspective of an asset of interest 102, and the map will change based on selection of a different asset of interest. For example, another asset in the asset map can be selected to be the asset of interest, and the asset map will be updated accordingly. If embodiments of the present invention were to be described as an ordered tree structure representing assets stored in memory in a computing environment, this asset map updating can be described as tree traversal.

The assets in the map can be arranged into groups that share a common folder. In known browsing applications, containment is shown in a hierarchical view in which contained folders and files are listed as various offsets from a margin. An asset map according to an embodiment of the present invention displays an asset of interest and other assets having a use relationship thereto, whether the assets are used in the asset of interest, or the asset of interest is used in relation to the other assets. The pyramid browsing technique can display true containment, and provides the option of showing which assets are contained within an asset of interest, as well as showing other assets in which the asset of interest is contained.

In FIG. 1, an asset of interest 102, or node, is provided in the middle of the graphical display, and is shown to be stored in a folder 104 entitled Projects. The asset of interest can be described at the root, or a root node, of an ordered tree structure, and is provided in a root area. A component area displays a number of component assets and provides a visual indication that the component assets are used in the asset of interest. The component area can be provided in a first visual relationship with respect to the asset of interest, such as to the left of the asset of interest 102. A component asset is an asset that is used or referred to in some manner, either in whole or in part, in the asset of interest 102, or in the creation thereof. For example, a component asset can be described as contained within the asset of interest, where either the entire component asset or a portion thereof is used in the asset of interest. The visual indication of the component area can be a component branch that joins the component asset(s) to the root node, and indicates that the component assets are used in the asset of interest.

In an embodiment, the present invention can provide a visual distinction between different types of component assets. A direct component asset, or first level component asset, can be described as an asset that is directly used in the asset of interest. In FIG. 1, some direct component assets 106 are stored in folder 108, while other direct component assets 110 are stored in folder 112. An indirect component asset 114, or second level component asset, is itself a component of one of the direct component assets 110. The indirect component asset 114 is shown as being stored in a folder 116, which itself is shown as being a sub-folder of two other folders.

A number of further asset nodes to the right of the asset of interest represent output assets that are generated outputs from the asset of interest. An output asset is an asset that is created using an asset of interest, either directly or indirectly. The asset of interest can be described as a component of, contained within, used by or used in the output asset. An output branch joins the output asset(s) to the root node, and indicates that the asset of interest is used in the output asset(s), such as to generate the output asset(s).

In an embodiment, the present invention can provide a visual distinction between different types of output assets. A direct output asset, or first level output asset, can be described as an asset that is output directly using the asset of interest. A plurality of direct output assets 118 are shown to be stored in folder 120. A plurality of indirect output assets 122 (or second level output assets) are themselves output from one of the direct output assets 118, which is itself an output based on the asset of interest 102 and is stored in folder 124.

As illustrated in FIG. 1, the root area, the component area and the output area can concurrently display logical usage relationships between assets and a location on storage media of the assets. Assets can be shown atop their containing folder and folders can be shown atop (or within) their containers. In other embodiments, a visual indicator that is visually associated with the asset can be used to represent an asset's storage location. The visual indicator can include text and/or an image, a particular colour, or any other indicator. The visual indicator can indicate a full physical storage path including a drive name and a hierarchy of folders and sub-folders in which the asset is stored. For example, a top-level output folder 126 is shown to contain the output asset folders 120 and 124. Moreover, a work folder 128 is shown to contain the component asset folders 108 and 112, as well as the output folder 126.

Alternatively, the visual indicator can indicate a first portion of the physical storage information, such as only a drive name or a top folder in the asset's full path. The partial indication of physical storage location can be used to reduce visual clutter in the display. For example, in an embodiment, output folder 126 and work folder 128 can be omitted from the asset map to show differences in relative physical storage location, without displaying the full absolute storage location difference. As another example (not shown), assets stored on a first drive (or in a first top-level folder) can be shown in a first colour (e.g. yellow), and assets stored on a second drive (or in a second top level folder) can be shown in a second colour (e.g. blue). A second portion of the physical storage information, such as the remaining path information for the asset's location, can be shown in a callout box or popup box when a pointer (such as a mouse pointer) hovers over a selected asset. Techniques similar to those used to generate text from ALT or Title tags in the hypertext markup language (HTML) can be used to display the remaining path information.

The display of both the features of asset relationships to one another and asset relationships to computer storage can be equally important when organizing assets.

The asset map according to an embodiment of the present invention can also be described as displaying assets in a backward usage relationship with respect to an asset of interest (i.e. any assets that are components of that asset of interest), and assets in a forward usage relationship (i.e. any assets for which the asset of interest is a component asset). Advantageously, embodiments of the present invention visually indicate relationships between an asset of interest and component assets, but also indicate relative relationships between component assets, and whether they are themselves components of other assets. Similarly, the asset map visually indicates relationships between an asset of interest and output assets, and also indicates relative relationships between output assets, and whether they are themselves output based on other output assets. Such a degree of visual indication of logical usage relationship, such as containment, has not previously been provided in operating system file browsers, or file browsers to be used in conjunction with an operating system.

File system operations available from this view according to an embodiment of the present invention are:

1. File/folder move
2. File/folder copy
3. File/folder rename

Navigation within this view is based on panning controls for left/right up/down movement in the asset map. The top left of FIG. 1 also shows a viewing indication area 130 in which the current view level can be displayed in relation to the asset level and the root level.

FIG. 1 also illustrates a “dashboard” portion 132 of the display, in which file or asset names and descriptions can be displayed. This dashboard 132 can show all recently edited files and their most recent edit time, or can show filenames and descriptions for all files in a particular project, or related to an asset of interest. Other options such as menu and viewing options are shown in FIG. 1. Links between asset nodes, or data entities, can be represented in different colors and used to represent all of the asset nodes/data entities that may have to be updated if another asset node was to change.

Near the bottom left had corner of FIG. 1, a tracker 134 is provided. The tracker, or tracker function, provides a visual overview of an entire set of related assets, documents, data entities, etc. This function, which can be provided as a tracker box, is particularly useful if the current view only shows a portion of the entire viewable area. The tracker box 134 can include one or more indicators, such as in FIG. 1, to highlight the asset of interest in the center of the box, and also indicate a position of the edge of the currently viewed area with respect to a total viewable area.

In an embodiment, a visualization tool, or asset map generator, can be provided to retrieve information from a database and present it to the user in a fashion that helps the user understand the relationship between their various application data files, including file and workflow versioning.

To utilize the information extracted from the parsed application data files, an embodiment of the present invention includes, or is in communication with, a persistent database in which the information is organized and stored. In an embodiment, an efficient means of modeling this information is to represent each file as a Node and each relationship between two nodes as a Link. A link includes sufficient information to describe the relationship of the source node and the destination node between which the link is provided.

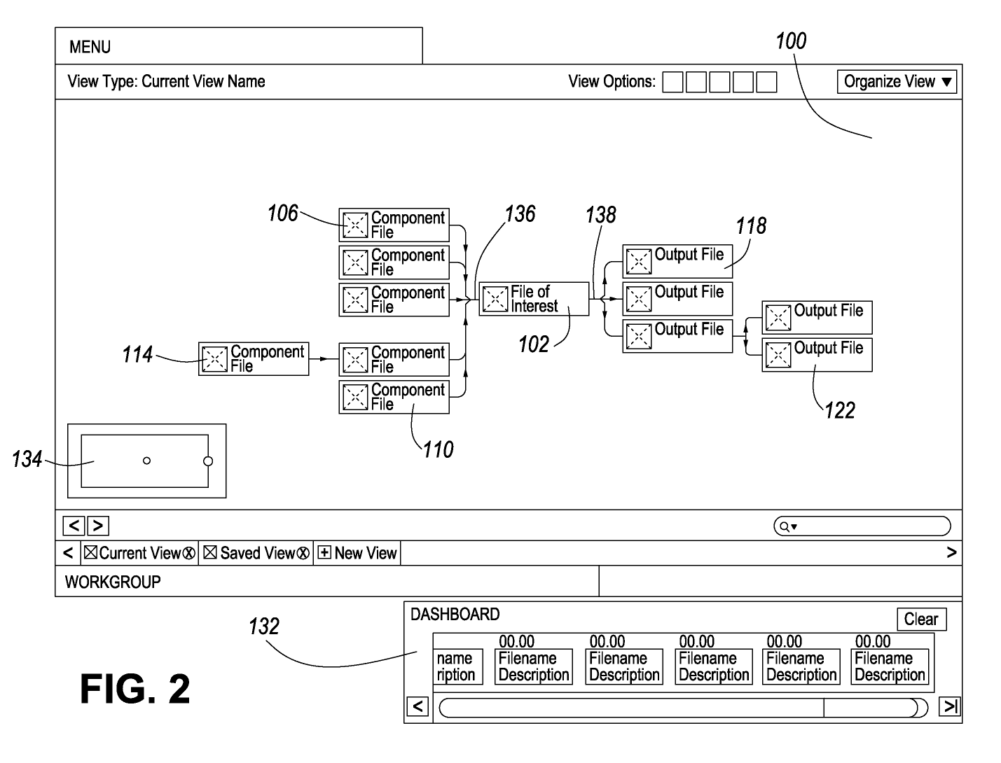

FIGS. 2-15 illustrate various displays based on an asset browsing system according to embodiments of the present invention. While these figures to do not show the display of a location on storage media of the various displayed assets, it is to be understood that embodiments of the present invention encompass implementations where the storage location information is concurrently displayed, along with the additional features described in relation to FIGS. 2-15. According to such embodiments, the omission of the storage location information in these figures is simply for the sake of ease of understanding of the drawings and reducing clutter. According to a different embodiment of the present invention, the display of storage location information can be omitted from the asset map.

FIG. 2 illustrates a display based on an asset browsing system according to another embodiment of the present invention. The embodiment of FIG. 2 uses similar numbering as in FIG. 1. While FIG. 2 does not show physical storage information in the asset map, the asset map displays an ordered tree structure representing assets in a computing environment, including a root node representing an asset of interest, one or more component assets and one or more output assets. The component branch 136 extends from the root node to the one or more component assets, the component branch indicating that the component assets are used in the asset of interest. The component branch can include direct component and indirect component sub-branches. The output branch 138 extends from the root node to one or more output assets, the output branch indicating that the output assets are outputs generated using the asset of interest. The output branch can include direct output and indirect output sub-branches.

In an embodiment, the asset browsing system of FIG. 2 provides a display that shows an asset of interest and provides a visual distinction between different types of component assets and output assets. In displaying logical relationships between the assets, the visual separation of direct and indirect component assets and/or direct and indirect output assets advantageously provides an asset browser that shows details that in known approaches would otherwise require investigating individual asset properties and leaving the main level of the asset browser.

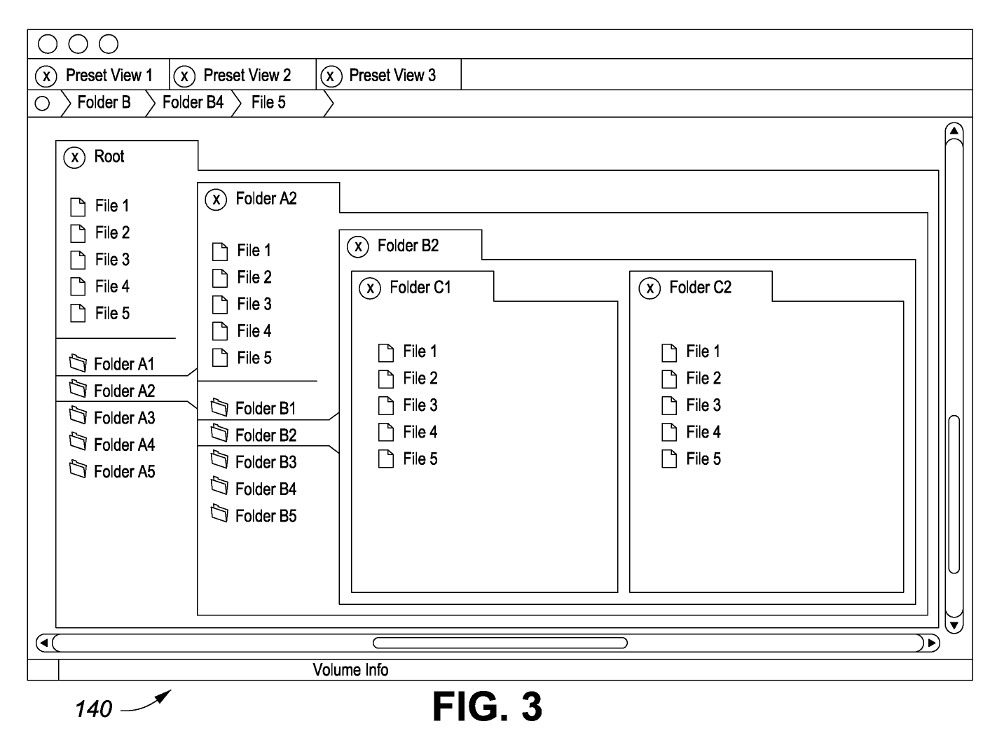

FIG. 3 illustrates a display 140 based on an asset browsing system according to a further embodiment of the present invention. This display 140 is an example of a second portion of the physical storage information, such as the remaining path information for the asset's location, which can be shown in response to selection of the asset of interest. In this embodiment, a selected asset or data entity can be displayed in terms of an overall hierarchical view with respect to storage. This display can be initiated by selecting an asset in a view such as the view of FIG. 1 or 2. Scroll bars are provided to scroll horizontally and vertically through the storage-based details.

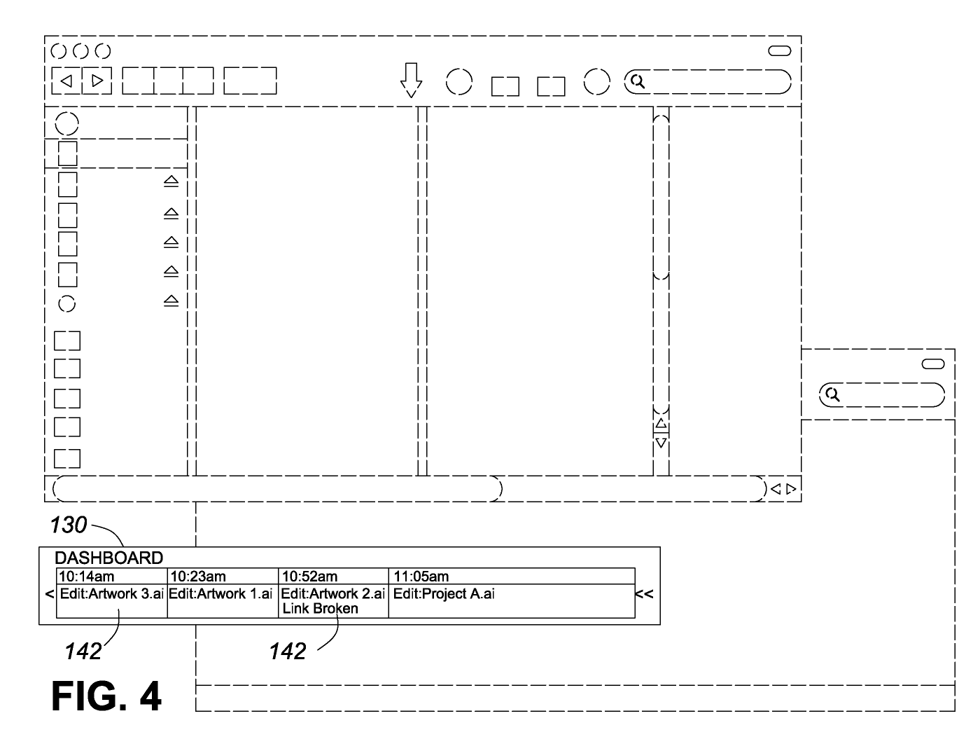

FIGS. 4-15 Illustrate screenshots of displays for an exemplary asset browsing system according to embodiments of the present invention. These screenshots can also be described as representing visualization tools, asset browsers, asset maps or user interfaces, based on a method, system, apparatus or computer-readable medium according to an embodiment of the present invention.

FIG. 4 illustrates the dashboard portion 130 displayed independently of an asset map, floating on top of other applications running in a given operating system environment. The dashboard, or dashboard application, includes a plurality of edit status areas 142 which display a listing of recently edited assets or files associated with a particular asset of interest, such as a project file. The edit status area can display the asset name of the edited asset, and can also show the time of last edit. In FIG. 4, the edit status area 142 for the file name Artwork2.ai also shows link information for that file, indicating that a link is broken. Other types of link information can also be provided, such as whether the asset is used by or used to generate another asset.

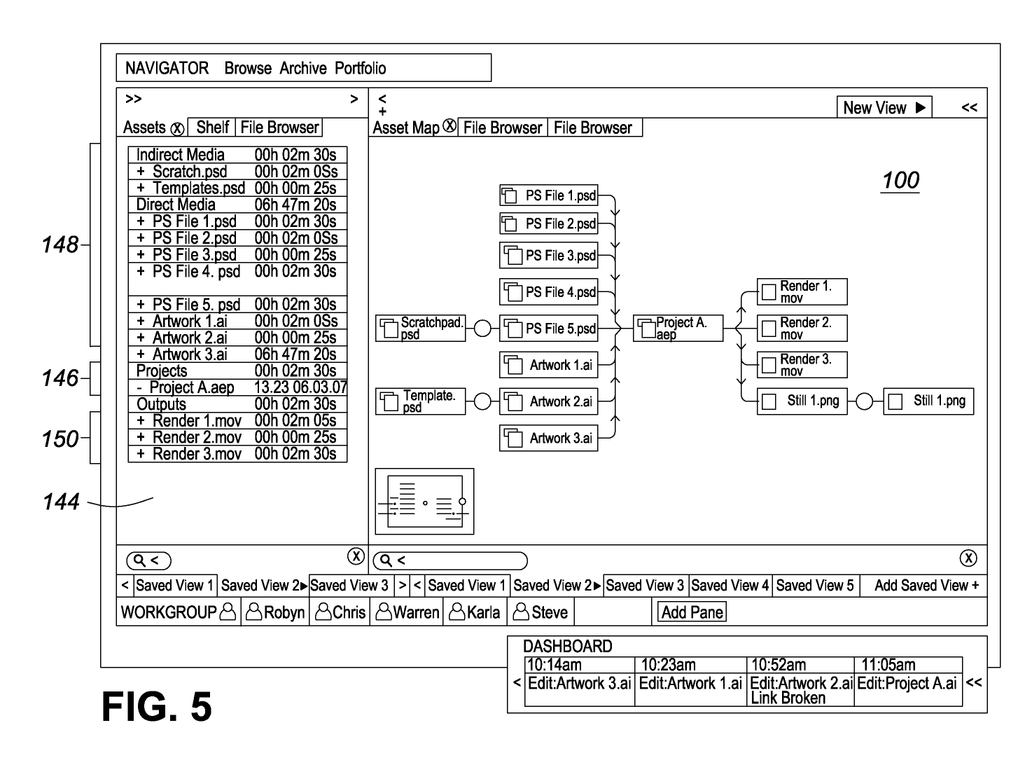

FIG. 5 illustrates an asset list 144, or asset browser, on the left side of the display. The asset list 144 shows an asset of interest named ProjectA.aep in an asset of interest area 146, or root area, which in this case is a project. A component asset area 148 shows the assets contained in the asset of interest. In the embodiment of FIG. 5, the component asset area 148 splits the component assets into indirect media and direct media, each with an edit time. The indirect media and direct media are examples of direct containment and indirect containment. An output asset area 150 displays outputs relating to the project.

According to an embodiment of the present invention, an asset browser, which can be implemented as an asset list 144 or as an asset map 100, provides an ordered tree structure representing assets stored in memory in a computing environment that are related to one another with respect to use. The asset browser can include a root area, a component area and an output area. The root area displays an asset of interest. The component area displays one or more component assets and provides a visual indication that the component assets are used in the asset of interest. The output area displays one or more output assets and visually indicates that the output assets are outputs generated using the asset of interest. In an embodiment, a component branch extends from the root node to the one or more component assets to indicate that the component assets are used in the asset of interest, and an output branch extends from the root node to one or more output assets to indicates that the output assets are outputs generated using the asset of interest.

Menu items are provided at the top of the entire application screen, with navigation tabs shown at the top and bottom of each of the left and right portions of the display. Workgroup information is also provided to show information on people working on the selected project. Each asset indication can also include an icon indicating the application with which the project or asset was created, such as Adobe AfterEffects or Adobe PhotoShop, or with which the project or asset can be displayed, such as Apple QuickTime.

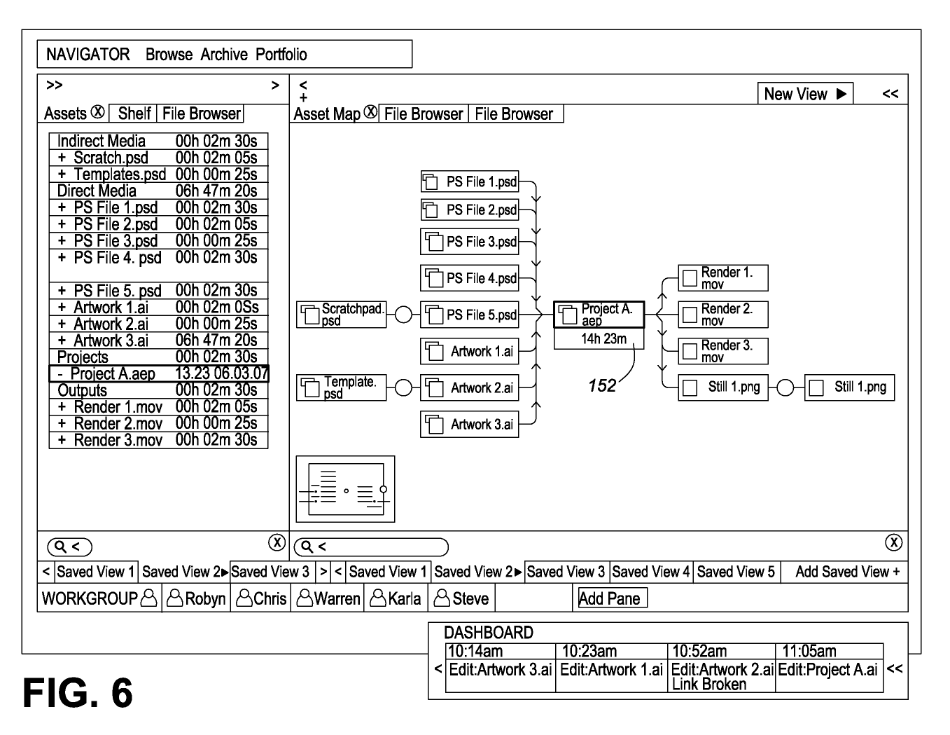

FIG. 6 shows the particular project being selected as well as a displayed total edit time 152 for a selected asset. A visual indication highlighting the selected asset, in this case the asset of interest ProjectA.aep, can be provided in one or both of the asset list and in the asset map. With respect to the displayed total edit time 152, this is a total edit time with respect to a particular time period and for the selected asset. For example, it can be the total edit time for the most recent version of the asset, or for all versions of the asset since its creation. In an embodiment, the time period can be modified based on user input or selection.

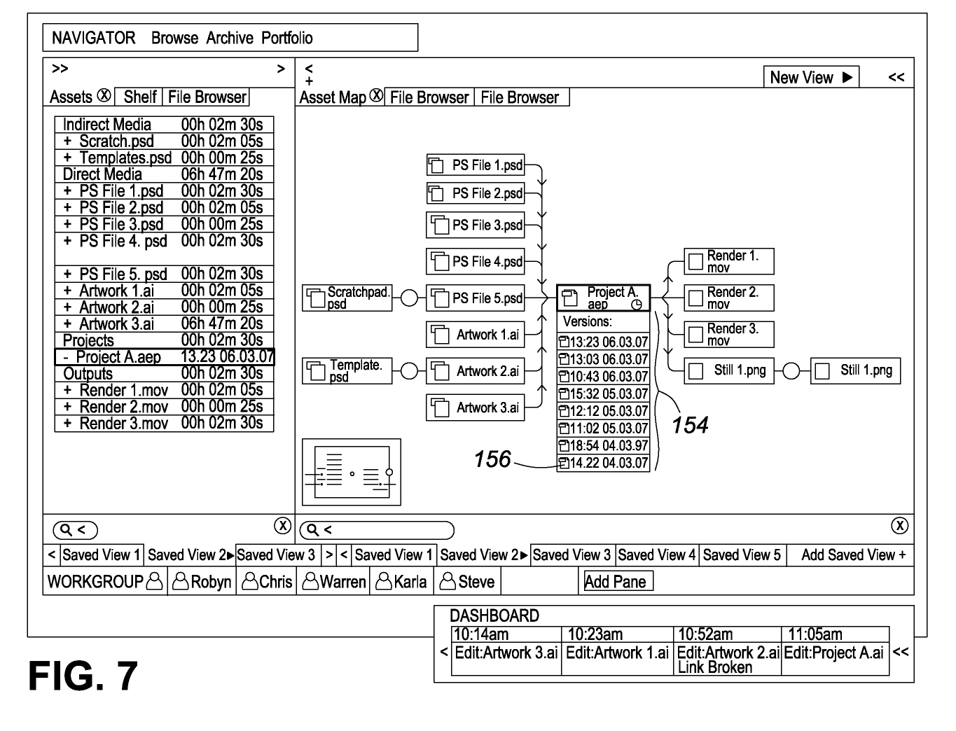

FIG. 7 shows version information for a selected asset. Though the version information is shown for one asset, it is to be understood that such version information can be concurrently displayed for a plurality of assets. The version information can include a version history 154 including one or more version entries 156. Each version entry 156 can include a version number and an edit time for the version, or any other related information. The version history and version entries can be displayed, either in part or in their entirety, in the asset map and/or in the asset listing. In an embodiment, in response to selection of a version in a previous version entry, the asset map is updated to reflect the assets and logical usage relationships at the time corresponding to the previous version entry.

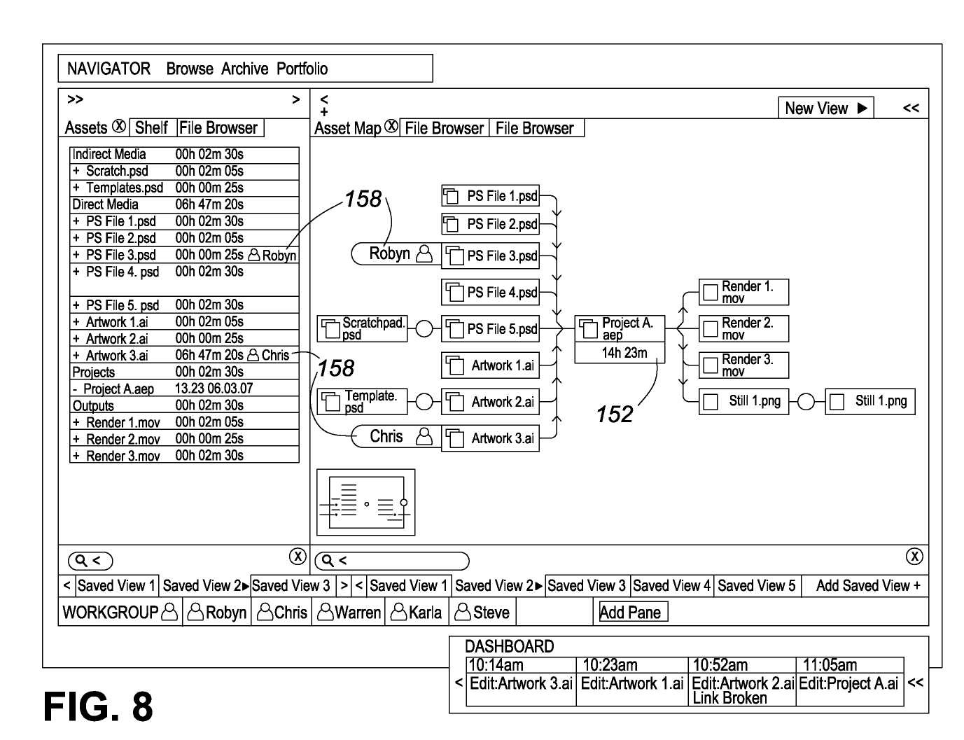

FIG. 8 shows a user name associated with particular files/assets on the asset map and the asset listing. In the example of FIG. 8, user name indications are provided in the asset map and the asset list. A first asset-specific user name indication 158 is used in the asset map to indicate that a user Robyn is associated with the asset PS File 3.psd. A second asset-specific user name indication 158 is used to indicate that a user Chris is associated with the asset Artwork 3.ai. Both of these indications are used to associate a user with a particular asset. In an embodiment, this association implies that the user is either using the asset, or is the last known user to modify the asset. Similar indications 158 are provided in the asset list, where the user name indication is associated with the amount of time the user has been editing, or working on/with, the asset.

A version-specific user name indication (not shown) can be provided in conjunction with version information as shown in FIG. 7 to associate a user name with a particular version of an asset. This can be particularly useful in a collaborative environment where many users work on, or with, a selected asset at different points in time. User name indications can be provided to associate a user name with any other type of asset information displayed in the asset list or asset map.

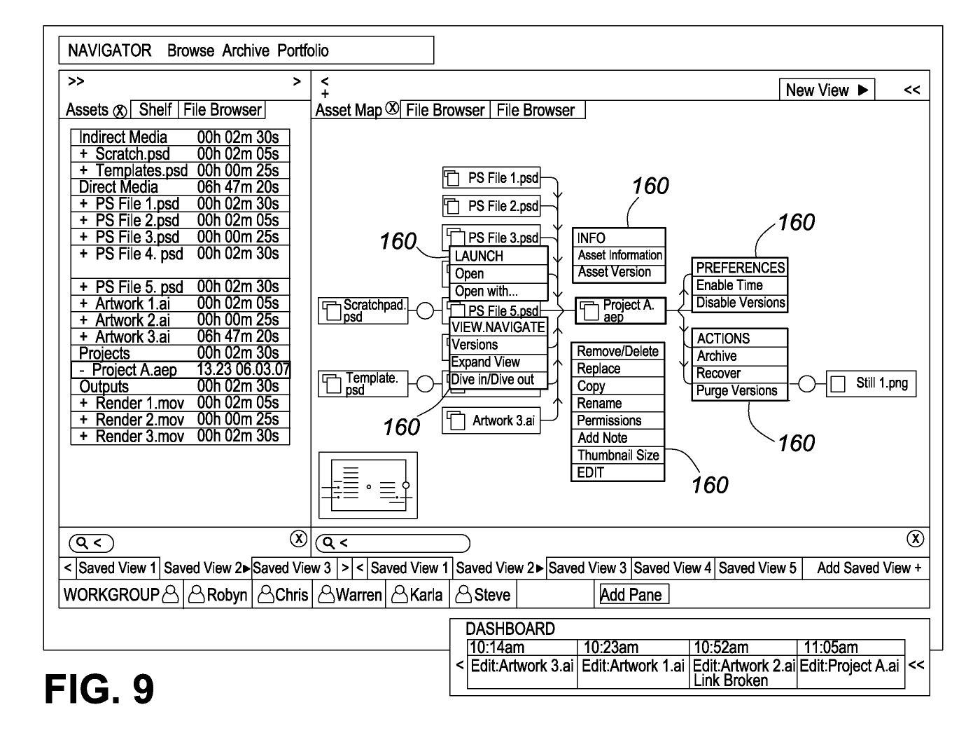

FIG. 9 illustrates a number of menu options 160 available for a selected file/asset. The menu options or commands are advantageously provided in a floating manner around the selected asset. Alternatively, the menu options can be provided in a menu bar and nested menu items as is commonly known. The floating menu options are grouped based on how they are related to one another. As shown in FIG. 9, menu items that would normally be shown on the menu bar can be distinguished based on text color or background color, and grouped with the menu commands that would have been listed under the particular menu items if they were to be presented in a menu bar. The menu item, such as “edit”, can be displayed at the top or bottom of the group of “edit” menu commands, or even on the side or as a background watermark. The menu items and commands available can be launched based on user selection of the asset, and based on knowledge of the file type of the asset. The menu options 160 can provide access to any information stored in memory about the asset, such as version information, edit times, and other information previously described. The menu options can also relate to commands accessible by a default program associated with the selected asset.

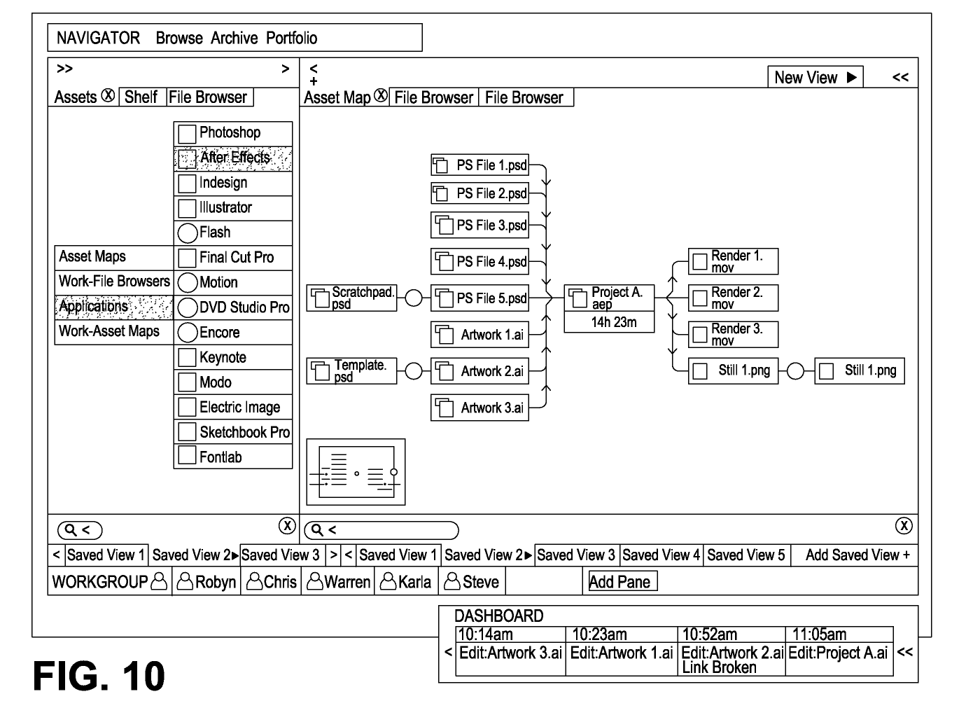

FIG. 10 illustrates a shelf view in the left portion of the display, rather than an asset view. This particular shelf view has asset maps, work-file browsers, applications, and work-asset maps. In FIG. 10, the Applications item is selected. This can be the application associated with the selected asset, such as Adobe After Effects, as shown. The asset map in FIG. 10 has not yet been updated in response to such selection.

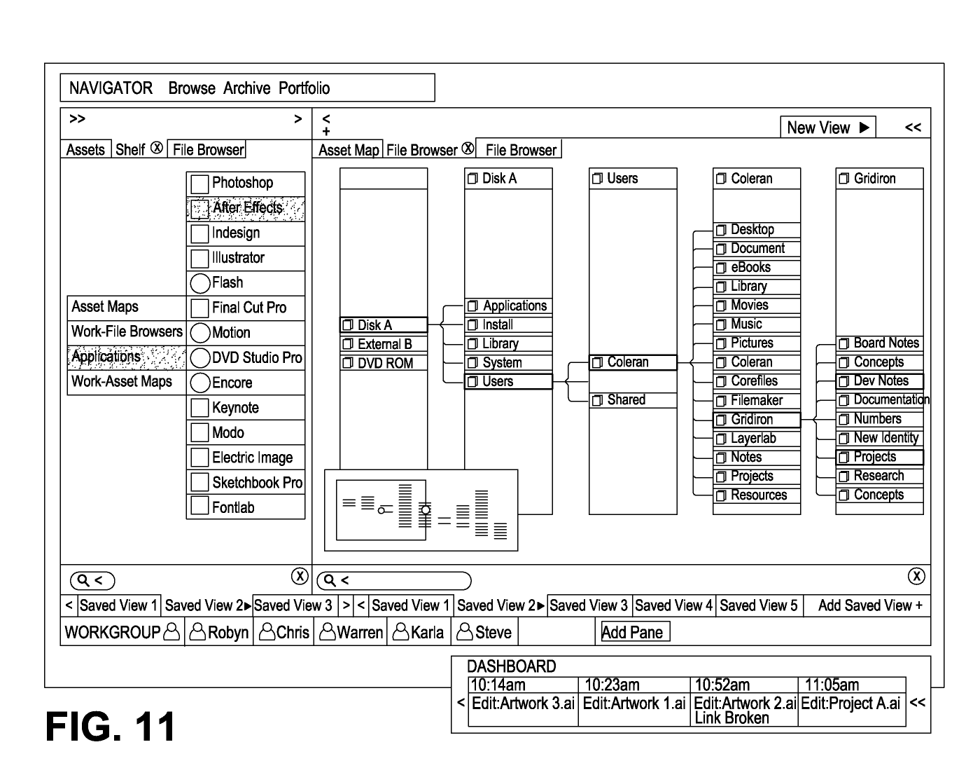

FIG. 11 shows an asset browser where the right side of the display has been updated to display a set of assets of interest related to the selected application in the left side of the display. In the previous figures, an asset map showed a single asset of interest, its storage location, and its logical usage relationships. FIG. 11 shows a hierarchical indication of storage location of the set of assets of interest. The tracker in FIG. 11 shows that the current view is only a portion of the total viewable area in the asset browser. The tracker also indicates where the viewed assets are within the current view, and shows the position of the current view within the total viewable area. The display in FIG. 11 is not wide enough to show the entire storage location hierarchy and the set of assets of interest themselves.

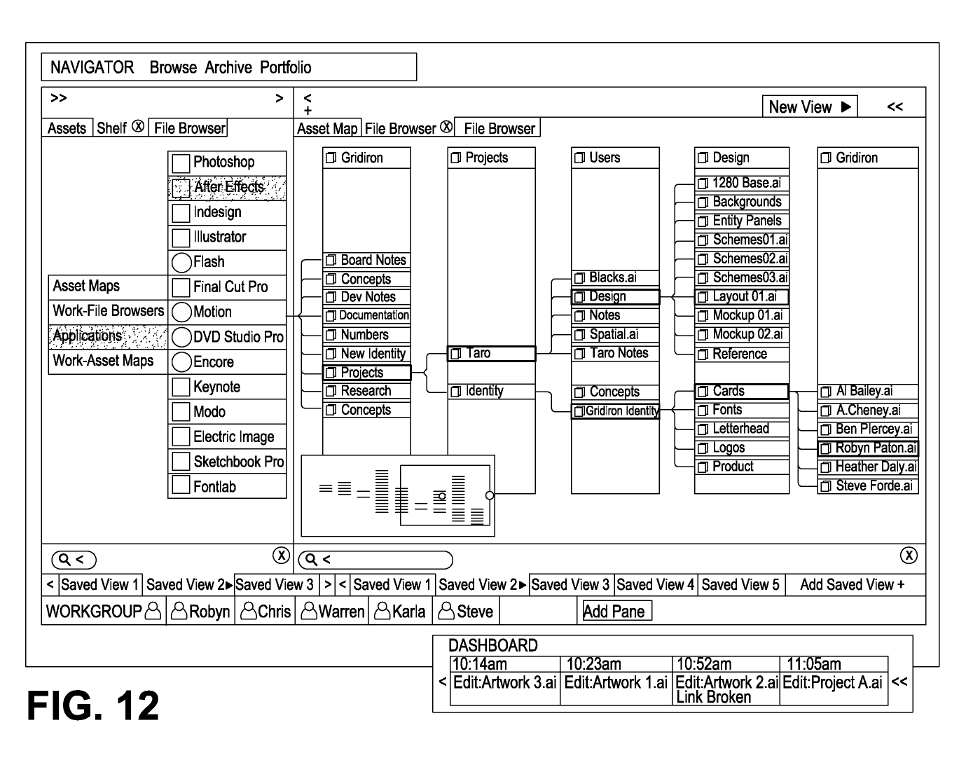

FIG. 12 is a further drill-down of the view of FIG. 10 to show layout and identity information. In FIG. 12, while the asset map does not show that the folder Projects is stored in a set of folders on Disk A, it does concurrently display the set of assets of interest and their location on storage media. The set of assets of interest includes all assets with the file extension *.ai. The display in FIG. 12 selectively displays only files associated with the selected application, and omits other files in the file system that are not associated therewith. A selected asset Robyn Paton.ai is highlighted in FIG. 12 from within the set of assets of interest.

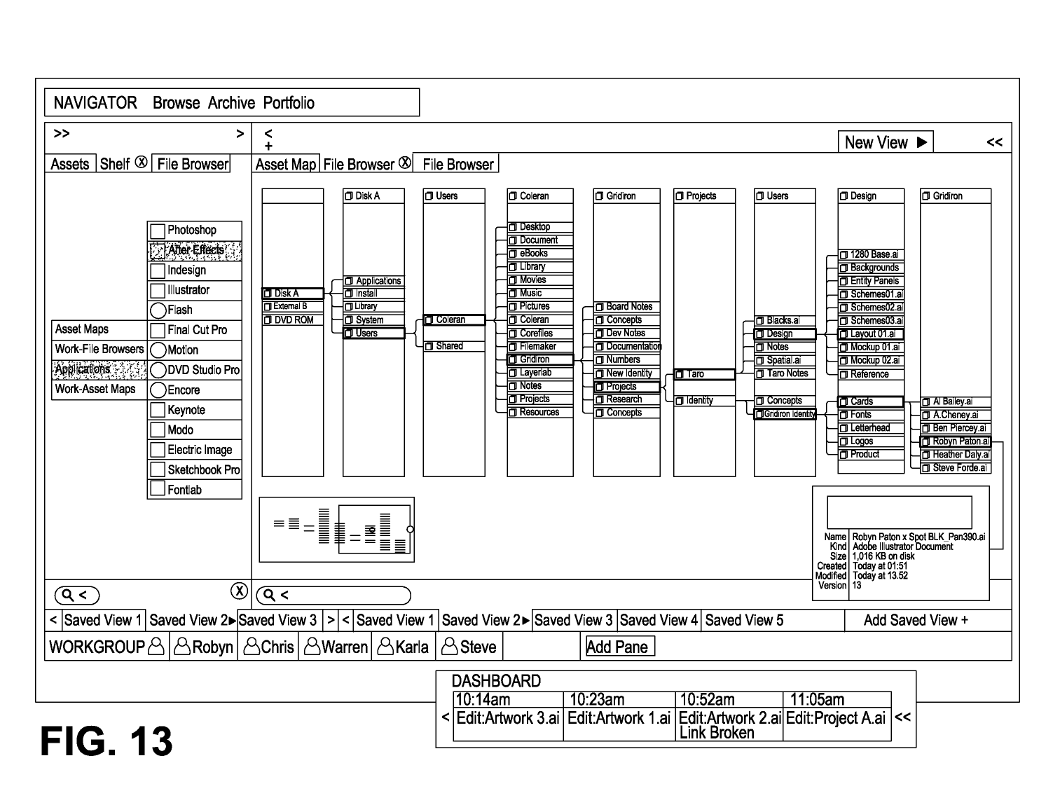

FIG. 13 is a wide screen view of an asset browser showing full drill-down to a business card image showing asset details. The asset map in FIG. 13 concurrently displays the set of assets of interest and a hierarchical indication of the location on storage media for each asset in the set of assets. The asset map in FIG. 13 also shows a business card view, or an asset preview, in which an asset can be previewed within the asset map in response to a request to preview the selected asset.

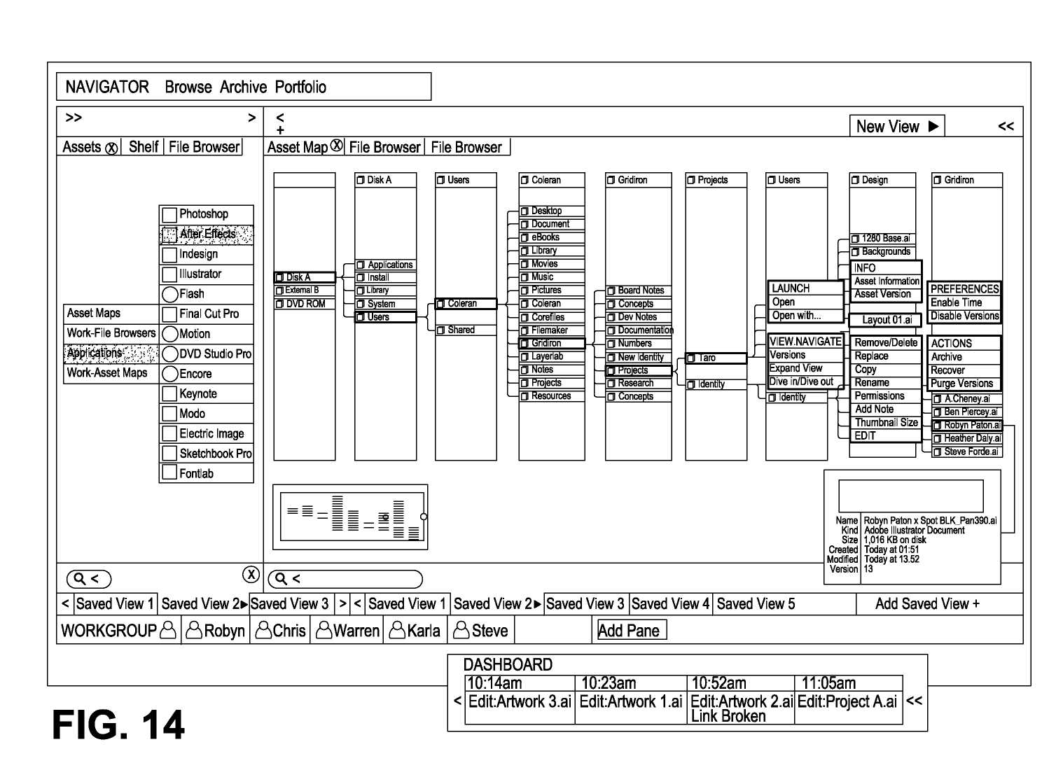

FIG. 14 is a modification of FIG. 13 showing floating menu commands surrounding a selected layout asset Layout 01.ai. The floating menu commands have been described in relation to FIG. 9. The display in FIG. 14 shows that the asset map can concurrently display an asset preview for a first selected asset and floating menu commands for a second selected asset, all while showing the location on storage of the set of assets of interest.

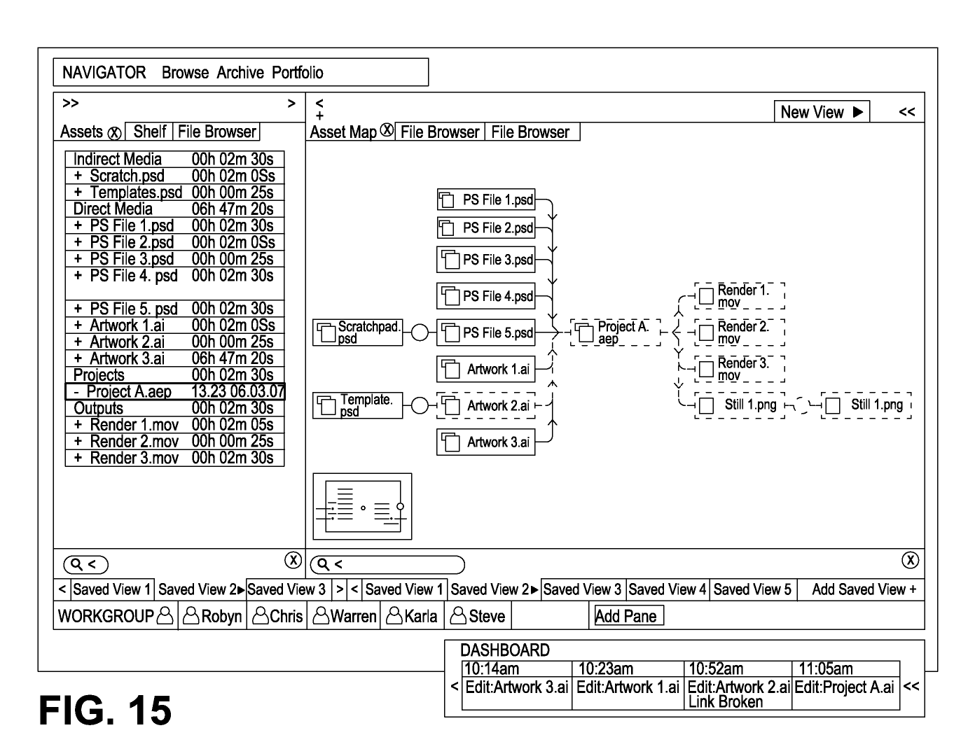

FIG. 15 illustrates an asset node named ProjectA.aep is provided in the middle of the graphical display, and is similar to the asset map shown in FIG. 5. The asset of interest in FIG. 15 is an Adobe After Effects motion graphics project file Project A.aep. It is often useful to know how an asset of interest, and other related assets, may change if another asset is modified. FIG. 15 provides a further visual indication representing all assets that may have to be updated if a selected asset is changed. In this case, the selected asset is Artwork 2.ai. Dashed lines are provided around the selected asset, around all assets that are output assets with respect to the selected asset, and on all links or branches joining the selected asset to output assets of the selected asset. Note that component assets of the selected asset will not need to be changed, and therefore are not displayed any differently. While dashed lines are used to provide the further visual indication, any other suitable visual indicator such as colour, line width, background colour for the displayed asset can be used to represent assets that may have to be updated if a selected asset is changed.

The embodiment in FIG. 15 also concurrently displays two different sets of logical usage relationships: a first set of logical usage relationships from the perspective of the asset of interest; and a second set of logical usage relationships from the perspective of the selected asset.

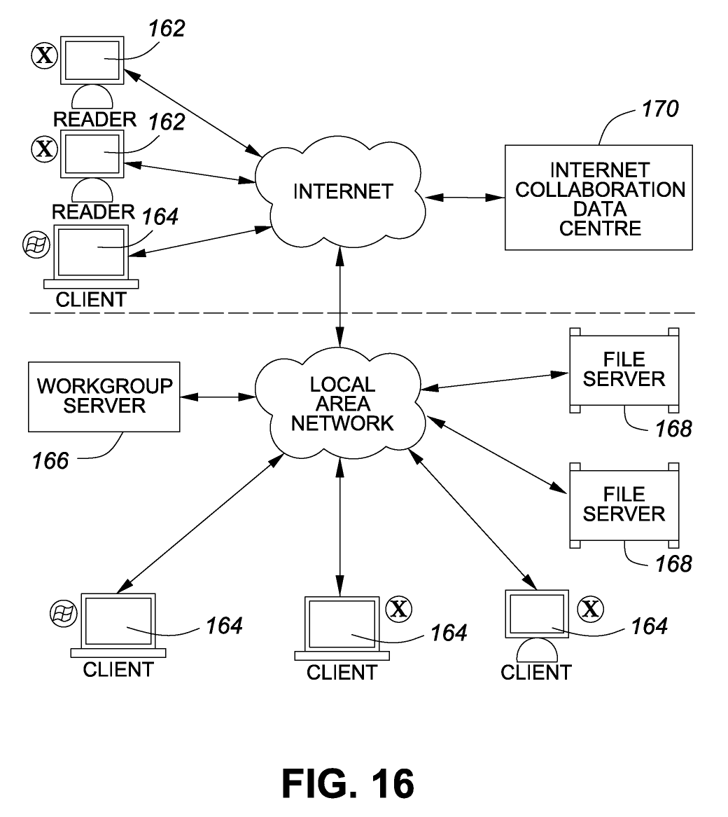

FIG. 16 illustrates a network diagram including a plurality of entities according to an embodiment of the present invention. Embodiments of the present invention can be provided as part of a suite of components including a reader 162, a client 164, a workgroup server 166, a file server 168, and an internet collaboration server 170. The reader 162 can be provided as a free web application that allows read-only use of asset maps via the internet collaboration server 170. The client 164 can be provided as full desktop client software for Mac and Windows that supports automatic creation of asset maps, automatic file versioning, automatic workflow versioning, and automatic time tracking. The client supports interaction with the file server 168 for automatic versioning of networked assets, and supports interaction with the workgroup server 166 for distributed asset map tracking and time tracking.

The workgroup server 166 comprises server software running on Mac or Windows that supports tracking or distributed asset maps and distributed time tracking. The workgroup server works in conjunction with the client software 164 to accomplish this task. The file server 168 comprises server software capable of running on Mac, Windows and Linux that supports automatic file versioning for network volumes exported via AppleTalk Filing Protocol (AFP), server message block (SMB), or network file system (NFS). The file server works in conjunction with the client software 164 to accomplish this facility. Finally, the internet collaboration server 170 comprises an internet hosted web application that provides the capabilities required for asset maps to be shared between desktop clients and non-users.

While the reader 162, the client 164, the workgroup server 166, the file server 168, and the internet collaboration server 170 are shown as independent entities, they can be provided as software or firmware that is stored in memory on an existing device.

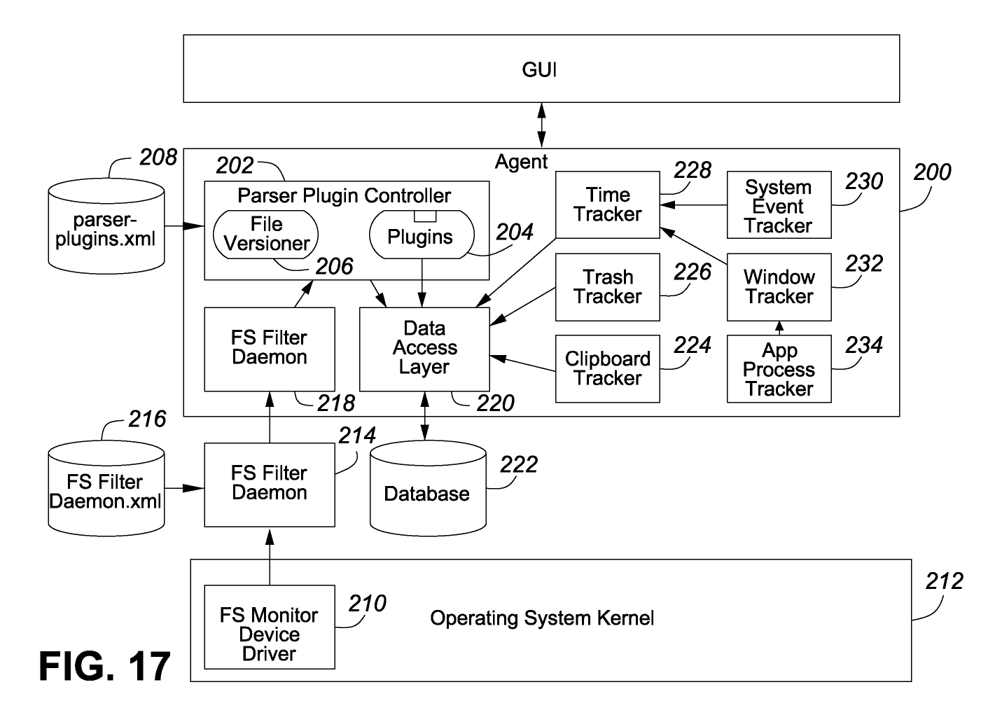

FIG. 17 illustrates a block diagram of a client design according to an embodiment of the present invention. This block diagram shows various elements that can be provided in a client 164, such as in relation to the system described in relation to FIG. 16. As illustrated in FIG. 17, an asset browser agent 200 can include a parser plugin controller 202, which itself can include plugins 204 and an asset versioner, such as a file versioner 206. The file versioner 206 can receive file relationship information from parser plugins 204, which it interprets according to the definitions provided by the parser-plugins.xml file 208. A file system monitor device driver 210 can be provided in an operating system kernel 212. The file system (FS) monitor device driver 210 can communicate with a file system filter daemon 214 that filters file system events detected by the FS monitor device driver according to a set of versioning events stored in an FS filter daemon.xml file 216.

A file system event monitor 218 in the asset browser agent 200 is in communication with the file system filter daemon 214 and the parser plugin controller 202. A data access layer 220 is also provided in communication with the parser plugin controller 202 and a database 222 as described earlier. A clipboard tracker 224, a trash tracker 226, and a time tracker 228 are in communication with the data access layer 220. A system event tracker 230 and a window tracker 232, which itself receives information from an application process tracker 234, are both in communication with the time tracker 228. These elements can co-operate to provide a system as described earlier, including at least some of the various functions described above and in the related applications referred to earlier.

While embodiments of the present invention have been described above in relation to “files” or “documents”, it is to be understood that these approaches also apply to other types of files, assets or data entities stored on computers, or on computer-readable media. Such assets or data entities can include, for example: applications; files; folders; fonts; effects; image layers; animation compositions; video tracks; and audio tracks.

In the above description, for purposes of explanation, numerous details have been set forth in order to provide a thorough understanding of the present invention. However, it will be apparent to one skilled in the art that these specific details are not required in order to practice the present invention. For example, specific details are not provided as to whether the embodiments of the invention described herein are implemented as a software routine, hardware circuit, firmware, or a combination thereof.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A graphical user interface providing an ordered display of assets stored in memory in a computing environment, the assets being logically related to one another with respect to use, comprising:
an asset map displaying an asset of interest and a plurality of assets having a logical usage relationship with the asset of interest, the asset map comprising:
a root area concurrently displaying an asset of interest and a location on storage media of the asset of interest;
a component area concurrently displaying one or more component assets, a location on storage media of the one or more component assets, and a visual indication that the component assets are used in the asset of interest; and
an output area concurrently displaying one or more output assets, a location on storage media of the one or more output assets, and a visual indication that the output assets are outputs generated using the asset of interest.

2. The graphical user interface of claim 1 wherein:
the visual indication that the component assets are used in the asset of interest comprises a component branch extending from the root area to the one or more component assets; and
the visual indication that the output assets are outputs generated using the asset of interest comprises an output branch extending from the root area to one or more output assets.

3. The graphical user interface of claim 1 wherein the one or more component assets comprise a direct component asset that is that is directly used in the asset of interest.

4. The graphical user interface of claim 3 wherein the one or more component assets comprise an indirect component asset that is a component of the direct component asset and is indirectly used in the asset of interest.

5. The graphical user interface of claim 2 wherein the component branch includes a direct component sub-branch and indirect component sub-branch, and the output branch includes a direct output sub-branch and indirect output sub-branch.

6. The graphical user interface of claim 1 wherein the displayed location on storage media of the asset of interest, the displayed location on storage media of the one or more component assets, or the displayed location on storage media of the one or more output assets comprises a complete physical storage path.

7. The graphical user interface of claim 1 wherein the displayed location on storage media of the asset of interest, the displayed location on storage media of the one or more component assets, or displayed the location on storage media of the one or more output assets comprises a partial indication of the physical storage location.

8. The graphical user interface of claim 7 wherein additional physical storage location information is displayed in response to a related request.

9. The graphical user interface of claim 1 wherein:
the visual indication that the component assets are used in the asset of interest comprises locating the component area in a first visual relationship with respect to asset of interest; and
the visual indication that the output assets are outputs generated using the asset of interest comprises locating the output area in a second visual relationship with respect to the asset of interest.

10. The graphical user interface of claim 1 further comprising a tracker to visually highlight the asset of interest and show the related component and output assets in a currently viewed area as it relates to a total viewable area.

11. The graphical user interface of claim 1 further comprising a dashboard to show asset names and associated properties of recently modified assets that are logically related to the asset of interest.

12. The graphical user interface of claim 1 wherein the asset map further concurrently displays a total edit time for at least one displayed asset.

13. The graphical user interface of claim 1 wherein the asset map further concurrently displays version information for at least one displayed asset.

14. The graphical user interface of claim 13 wherein the asset map further concurrently displays a version history for at least one displayed asset, the version history comprising at least one version entry.

15. The graphical user interface of claim 14 wherein, in response to selection of a previous version entry of the at least one displayed asset, the asset map is updated to reflect component and output assets in a logical usage relationship with the at least one displayed asset at the time of the previous version entry.

16. The graphical user interface of claim 1 wherein the asset map further concurrently displays a user name associated with at least one displayed asset.

17. The graphical user interface of claim 1 wherein, in response to user selection of a selected asset, the asset map further concurrently displays command options available for the selected asset, the command options being provided in a floating menu around the selected asset.

18. The graphical user interface of claim 1 wherein, for a selected asset in the asset map, the asset map associates a unique visual indicator with a set of assets that are affected if the selected asset were to be modified.

19. A system for browsing assets stored in memory in a computing environment, the assets being logically related to one another with respect to use, comprising:
an asset information acquirer to obtain logical usage relationship information and storage information for an asset of interest and for a plurality of assets that have a logical usage relationship with the asset of interest; and
an asset map generator to generate an asset map concurrently displaying the asset of interest and the plurality of related assets, a location on storage media of the asset of interest and the plurality of related assets, and a visual indication of a nature of the logical usage relationship between the asset of interest and each of the plurality of related assets.

20. The system of claim 19 wherein the displayed plurality of related assets comprise component assets used in the asset of interest, and output assets generated using the asset of interest.

21. The system of claim 19 further comprising:
a logical usage relationship extractor to obtain logical usage relationship information for the asset of interest and for the plurality of related assets; and
a storage information extractor to obtain storage information for the asset of interest and for the plurality of related assets.

22. The system of claim 19 wherein the asset information acquirer and the asset map generator are provided independent of an application in which assets are generated.

23. A method for browsing assets stored in memory in a computing environment, the assets being logically related to one another with respect to use, comprising:
obtaining logical usage relationship information and storage information for an asset of interest and for a plurality of assets that have a logical usage relationship with the asset of interest; and
concurrently displaying: the asset of interest and the plurality of related assets, a location on storage media of the asset of interest and the plurality of related assets, and a visual indication of a nature of the logical usage relationship between the asset of interest and each of the plurality of related assets.

24. A computer readable medium containing computer instructions which, when executed, cause a processor to provide a graphical user interface for browsing assets stored in memory in a computing environment, comprising:
instructions for obtaining logical usage relationship information and storage information for an asset of interest and for a plurality of assets that have a logical usage relationship with the asset of interest; and
instructions for concurrently displaying: the asset of interest and the plurality of related assets, a location on storage media of the asset of interest and the plurality of related assets, and a visual indication of a nature of the logical usage relationship between the asset of interest and each of the plurality of related assets.

25. An ordered tree structure representing assets stored in memory in a computing environment, comprising:
a root node representing an asset of interest;
one or more component assets;
a component branch extending from the root node to the one or more component assets, the component branch indicating that the component assets are used in the asset of interest;
one or more output assets; and
an output branch extending from the root node to one or more output assets, the output branch indicating that the output assets are outputs generated using the asset of interest.
